(19) United States
(12) Patent Application Publication
(10) Pub. No.: US 2002/0059263 A1
(43) Pub. Date: May 16, 2002

(54) Data management system for storages

(76) Inventors: Seiji Shima, Odawara (JP); Masaharu Murakami, Odawara (JP); Yoshio Mitsuoka, Odawara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/769,270

(22) Filed: Jan. 26, 2001

(30) Foreign Application Priority Data
Jun. 27, 2000 (JP) 2000-197861

(51) Int. Cl. G06F 7/00

(52) U.S. Cl. 707/100

(57) ABSTRACT

Files in various file formats for different operating systems coexist even under the environment where a number of storage devices are connected to a faster data transfer network such as SAN. The storage management so far has been always attained under the control of an operating system of a host.

The present invention provides a SAN-FM server, having a SAN-FS for converting files in a format specific to the operating system into files in a format common to the SAN, for managing files on the storage devices from a SAN-FM to allow to access by a common file among storage devices.

### BACKGROUND OF THE INVENTION

1. Field of the Invention

The present invention relates to a file storage management system in a computer system allowing data in different formats to be coexisted.

2. Description of the Prior Art

So far, the storage devices using rewritable recording medium such as magnetic disk devices are attached to a host in one-to-one relationship with the host, on which the operating system (OS) serves the management of data input/output (I/O) therebetween. As the storage capacity is drastically increasing year by year, while downsizing is a trend recently spread widely, as the consequence a disk array device having a plurality of large capacity disk drives was emerged. Now that the technology has already been far more advanced since then, a RAID (redundant array of inexpensive drives) device with higher reliability and redundancy has been achieved. Such a RAID storage device has a plurality of ports for interconnecting to other devices, each of which port may be connected to a host, so that a device may be placed in a one-device-to-many-host relationship. However, on the other hand, as the technology for recognition of storage devices from the host side remains at the level in which a host specifies the path to a storage device to interface to read/write from/to the device on one-by-one basis. This scheme has resulted in a mess of intermingled data of incompatible data formats in a RAID device.

In addition, SAN (Storage Area Network) technology is spreading in the purpose of improving data transfer rate of the storage devices. The SAN technology allows a number of hosts and storage devices to be interconnected through a fiber channel network to enable a data traffic far more faster than ever seen in LAN, as well as a data transfer between two storage devices at a faster rate without a need of contribution of their host computers.

As an exemplary file conversion scheme already known in the art, the Japanese Unexamined Patent Publication No. H11-134227 discloses a file format conversion method from a file system of an OS to another file system of another OS. Those skilled in the art may appreciate that the above disclose does not consider any adaptation to a new environment including such as the connection of storage devices through SAN.

As have been described above, the Prior Art technology assumes a storage device having a plurality of ports is shared by different operating systems (each has its own file system). The file system in each OS is a mass of data of different presentation and meanings in the storage system formatted in aproprietary file format, so that the OS reads and writes directly to and from the storage device to obtain the file data in question. Therefore in the storage there are intermixed data of incompatible formats.

In such a situation the storage device has no way other than the data management as “the mass of data for each different OS basis” or “a set of storage medium”. The storage management including automatic expansion of volume capacity in the storage device has to be achieved always under the control of an OS.

### BRIEF SUMMARY OF THE INVENTION

The present invention has been made in view of the above circumstances and has an object to overcome the above problems and to provide in a computer system incorporating a high-speed data transfer technology such as SAN, a versatile data management for managing data by the chunk of meanings (for example, on the file basis) in the storage device, which may provide theoretically unlimited capacity to the user without concern about the type of operating systems.

The present invention has a facility for converting a semantic block of data (for example, as a unity of file) having a format specific to a host into a commonly used format for a plurality of storage devices. The present invention further provides a server for controlling these plural storage devices apart from the hosts. A file system commonly used among these storage devices will be built so as to have access to the commonly shared block among devices.

The above and further objects and novel features of the present invention will more fully appear from following detailed description when the same is read in connection with the accompanying drawings. It is to be expressly understood, however, the drawings are for the purpose of illustration only and not intended as a definition of the limits of the present invention.

### BRIEF DESCRIPTION OF THE SEVERAL VIEWS OF THE DRAWINGS

In the drawings:

FIG. 1 is a schematic block diagram of a file storage management system in accordance with the present invention;

FIG. 2 is a schematic block diagram of devices within a RAID device in accordance with the present invention;

FIG. 3 is a schematic diagram of SAN file directories in accordance with the present invention;

FIG. 4 is a schematic block diagram of a database managing the storage in a LUN (logical unit number) in accordance with the present invention;

FIG. 5 is a table of storage in a LUN in accordance with the present invention;

FIG. 6 is a schematic diagram of a manager database in a RAID in accordance with the present invention;

FIG. 7 is a schematic block diagram of facilities of the file management system in accordance with the present invention;

FIG. 8 is a flow diagram of file conversion in accordance with the present invention;

FIG. 9 is a schematic block diagram of file management system database in accordance with the present invention;

FIG. 10 is another schematic block diagram of file management system database in accordance with the present invention;

FIG. 11 is a flow chart of file manipulation within the file management system in accordance with the present invention;

FIG. 12 is another schematic block diagram of file management system database in accordance with the present invention;

FIG. 13 is a flow chart of capacity error process in the file management system in accordance with the present invention;

FIG. 14 is another flow chart of capacity error process in the file management system in accordance with the present invention.

### DETAILED DESCRIPTION OF THE INVENTION

A detailed description of one preferred embodiment embodying the present invention will now be given referring to the accompanying drawings.

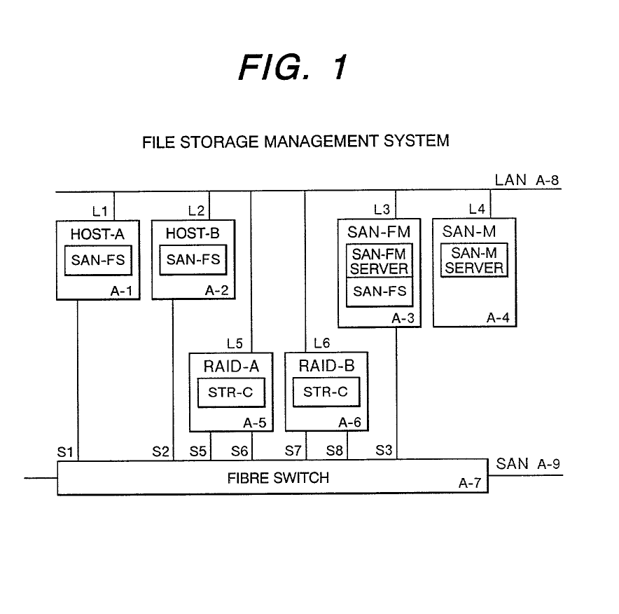

In FIG. 1, a host A (A-1) , host B (A-2) , SAN-FM (filemanager) (A-3), SAN-M (manager) (A-4), RAID A (A-5), RAID B (A-6) are interconnected with their respective connection lines L1 through L6 in a LAN (A-8). These components are also connected through a fibre switch (A-7) to a SAN (A-9) via their respective ports S1 through S8. The hosts A and B may be workstations, SAN-FS and SAN-M may be server manager stations, RAID A and B may be RAID devices with fibre I/F. The hosts A and B, SAN-FS, SAN-M are assumed to run on different operating systems. The hosts A and B may have access to the logical devices (logical volumes) within the RAID A and B, which may have a plurality of Fibre ports with a unique ID (S5 through S8), each of these ports being capable to connect to the SAN (A-9).

FIG. 1 depicts devices connected to only one fibre switch, which may be connected to other fibre switches (not shown in the figure) through SAN (A-9). In this topology an unlimited number of RAID devices may be interconnected through the SAN.

As shown in FIG. 1, there are a SAN-FM and SAN-M independent from any hosts in the system. The storage devices thereby may be separated from any hosts so as to enable flexible data transfer between devices, irrespectively of the file type on a host. This is one key aspect featured by the present invention, the structure and the operation thereof will be described later in greater details. It should be noted here that the term “RAID” is used herein as a storage device having redundancy in drive units of storage, and having a plurality of ports. In the present invention, the storage may be of any kind of external device attached to the host, not limited to the RAID device. A host may be a superior device to the storage devices.

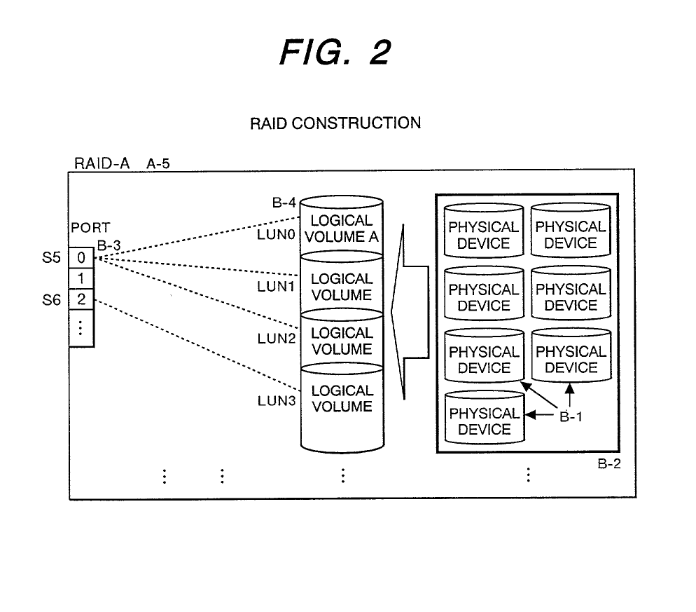

In FIG. 2, within a RAID, there are a plurality of physical device groups (B-2) (referred to as physical volume groups or ECC groups herein) each consisted of a plurality of physical devices (B-1) (for example, disk drives). A physical volume may be partitioned, as is well known in the art, logically into a plurality of logical volumes of an arbitrary size (B-4). Each logical volume has its unique LUN (logical Unit Number—that defines the path between the disk and the host). Since the logical volumes may be connected through their ports, for example, when specifying the WWn of a host, the WWn of a port, and a logical volume, a path requirement for the data transfer between that host and that RAID device will be satisfied. The configuration of logical volumes may be managed as part of system management data in the RAID-DB in the RAID.

For example, for a RAID system as shown in FIG. 2, a host may be capable of manipulating data (data update, correction, delete, and addition) on the logical volume A (B-4) when accessing LUN 0 from the port 0 (S5). Assuming that each port has an arbitrary name, WWn, a host may be able to specify the routing information (WWn of host itself, WWn of the RAID, the port 0 (S5), and LUN 0) in order to manipulate the logical volume A.

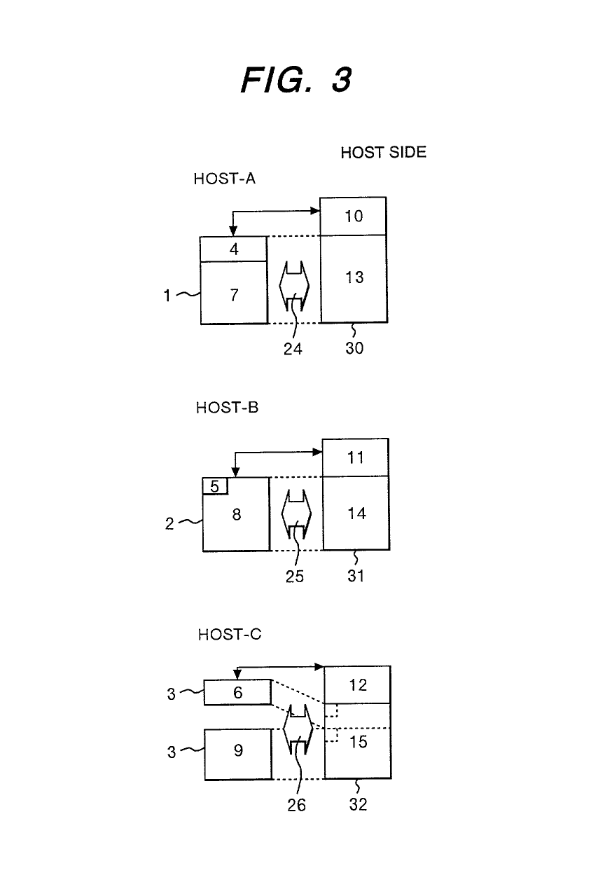

Now referring to FIG. 3, there is shown schematically the file conversion in accordance with the present invention. The term “file” is a typical unity of a semantic set of data as have been described above, and in the following description files will be used as examples, however any other units may be used instead. In general, files (1, 2, 3) are composed of a control section (4, 5, 6) and informative section (7, 8, 9). The control section (4, 5, 6) may have different file definitions from a host to another, as well as a variety of structural forms of the section as shown in the figure. In other words, each file has its own file type specific to a host. In accordance with the present invention, a commonly shared file control section (10, 11, 12) will be generated while extracting any necessary information from the original control section (4, 5, 6) so as to “wrap” the file specific to a host. The original files (1, 2, 3) specific to a host may be processed as whole as the informative (data) section (13, 14, 15).

In the present embodiment, the data section (13, 14, 15) will be encrypted by the SAN ID (K-1) as will be described later. More specifically, the conversion (24, 25, 26) of a file specific to a host will be consisted of generation of commonly shared control section and encryption of entire data section.

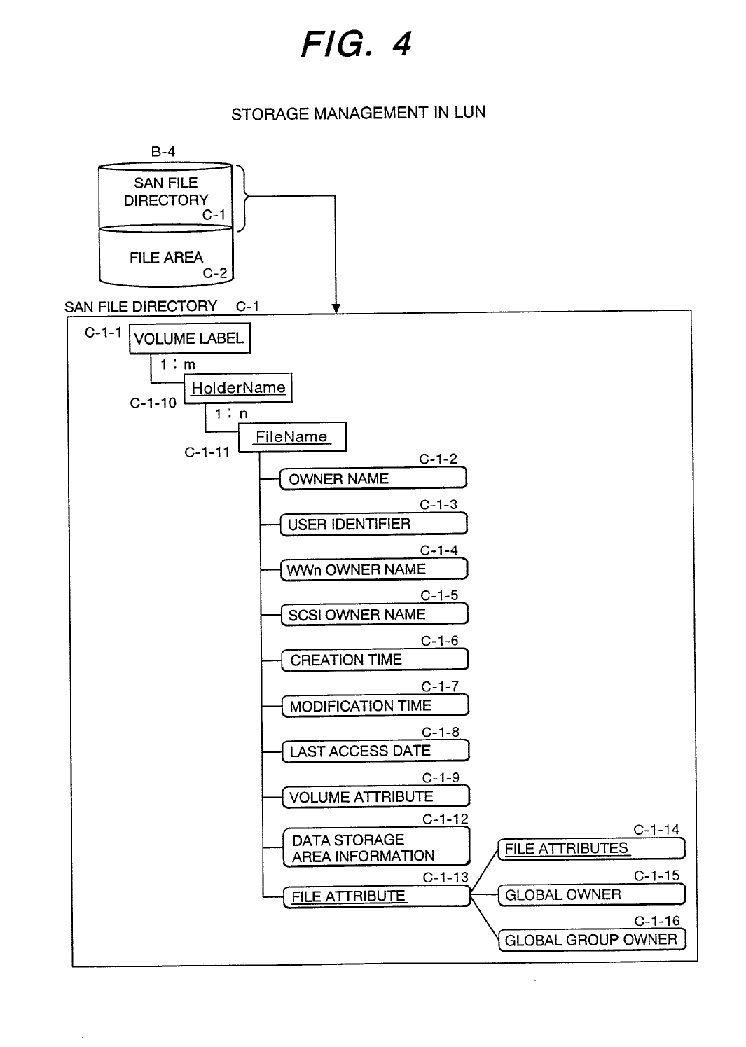

Now referring to FIG. 4, there is shown a logical volume commonly shared by the SAN and the structure of LUN thereof. Files (30, 31, 32) will be stored in an appropriate LUN. A LUN is consisted of a SAN file directory (C-1) and file area (C-2). Any necessary information will be extracted from the control section (for example, 10) of a file (for example, 30) stored in a LUN, and stored in the SAN file directory (C-1), and the file (30) itself will be stored in the file area (C-2). The file stored in the file area (C-2) will be linked to the directory so as to be selected and pointed from the SAN file directory (C-1).

The logical volume (B-4) is consisted of a SAN file directory (C-1) and a file area (C-2) and stores a plurality of files. The SAN file directory (C-1) maintains the system management information (E-5) and the like, in the form of hierarchical structure like a file directory (this hierarchy may have duplicated files or directories depending on the reliability issue, such as mirroring).

In the file area (C-2), actual file data will be stored. In the SAN file directory (C-1), a plurality of volume labels (C-1-1) is present for enabling multiplex managements. The volume labels (C-1-1) has one-to-many relationship with the Holder Name (C-1-10), which in turn may contain intrinsic attributes and names and may have one-to-many relationship with the File Name (C-1-11), which further may contain intrinsic attributes and names and have attributes such as the owner name (C-1-2), the user ID (C-1-3), the WWn owner name (C-1-4), SCSI owner name (C-1-5), the creation time (C-1-6), the modification time (C-1-7), the last access time (C-1-8), the volume attribute (C-1-9), and so on.

Information concerning the SAN volumes may be stored in the volume attribute (C-1-9). In the owner name (C-1-2) management information (security information and the like) on the SAN may be recorded. In the user ID (C-1-3) management information (security information and the like) on the SAN may be recorded. In the WWn owner name (C-1-4) information on the connected WWn (of host side) that manages the LUN and on the connected WWn (of the RAID device side) may be recorded. In the SCSI owner name (C-1-5) information on the SCSI path of which the LUN is under the control may be recorded. In the creation time (C-1-6) (of the connected host and connected device) the creation time of the volume may be recorded. In the modification time (C-1-7) the last modification time of any of files in the volume may be recorded. In the last access time (C-1-8) the last access time of any of files in the volume may be recorded.

In addition, the File Name (C-1-11) may have a file attribute (C-1-13), data storage area information (C-1-12) and the like for each file. The file attribute (C-1-13) further contains the global owner (C-1-15), the global group owner (C-1-16), and the file attribute (C-1-14). The global owner (C-1-15) may store an owner name (or a password) arbitrary determined by an operator (human being) administering the system, the global group owner (C-1-16) may store an owner group name (or pass word) arbitrary determined by the operator (human being) administering the system, and the file attribute (C-1-14) may store detailed file attributes of each file, required when the operator manipulates the files, as well as some intrinsic information such as OS-AP-FS. In the data storage area information (C-1-12) file information on the file stored in the file storage area (such as file pointers, file data addresses) may be stored such that the operator may determine how and in which condition the data stored in the file storage was created.

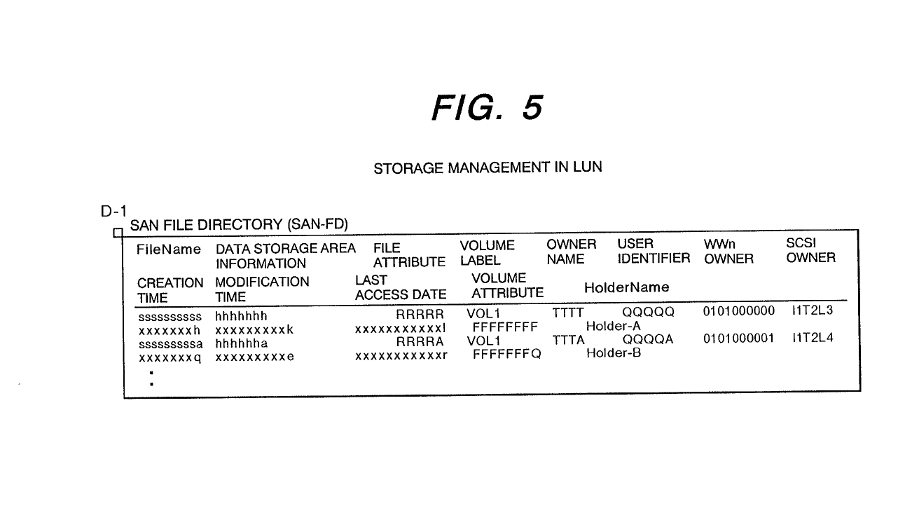

Now referring to FIG. 5, there is shown some information extracted from the LUN by using the File Name as a key. This information items will be stored in the G-DB in the host for the future file management. More specifically, the information items may be used for accessing the logical volume from a host to the RAID by specifying the target file name and determining the path to the file.

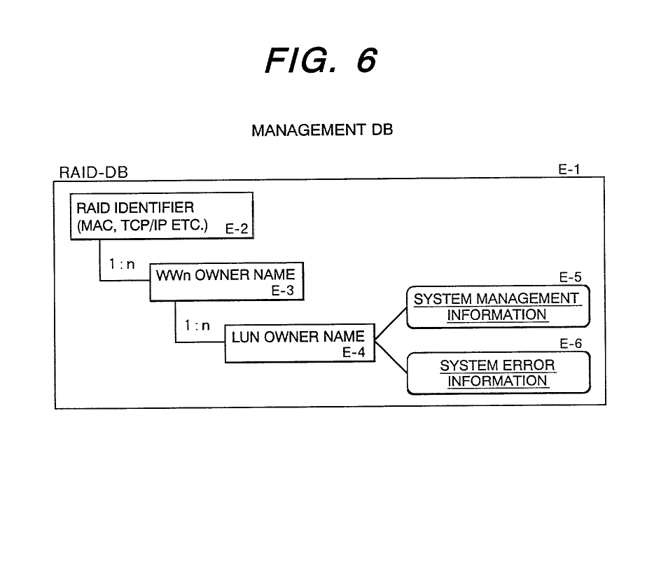

Now referring to FIG. 6, there is shown a RAID-DB, which is used for the management in the RAID. The RAID-DB is served for the management of path information, storing some information on the volume configuration, and the volume error. In the figure RAID intrinsic name (E-2) may have intrinsic attributes, and maybe unique and specific name, and has one-to-many relationship with the WWn owner name (E-3). The WWn owner name (E-3) may have its intrinsic attributes, and an arbitrary name (data may be mirrored on the port basis by overlapping the WWn owner name) as well as one-by-one relationship with the port and one-to-many relationship with the LUN owner name (E-4). In the LUN owner name (E-4) some management information including system management information (E-5) , system error information (E-6) and the like may be stored. In the system management information (E-5) information containing the SAN file directories of the LUN in the RAID and the like may be stored (the physical device configuration dependent on the RAID may also be stored). In the system error information (E-6) some information on the crash and/or error including PIN, degeneration, obstruction, and the like.

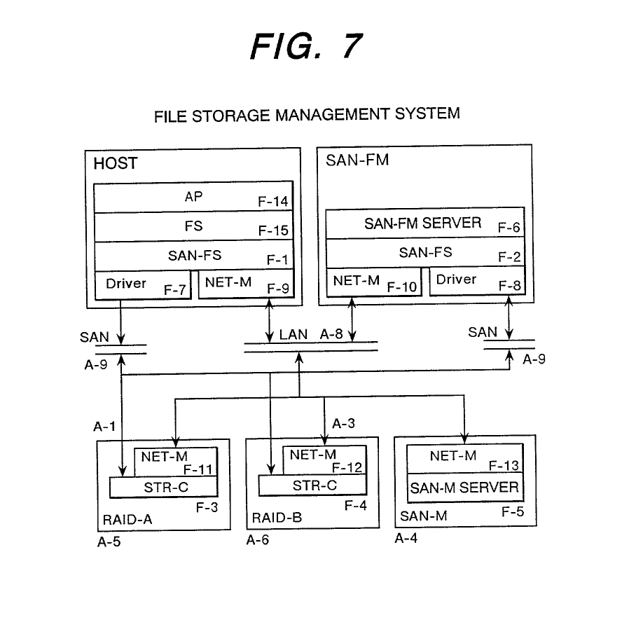

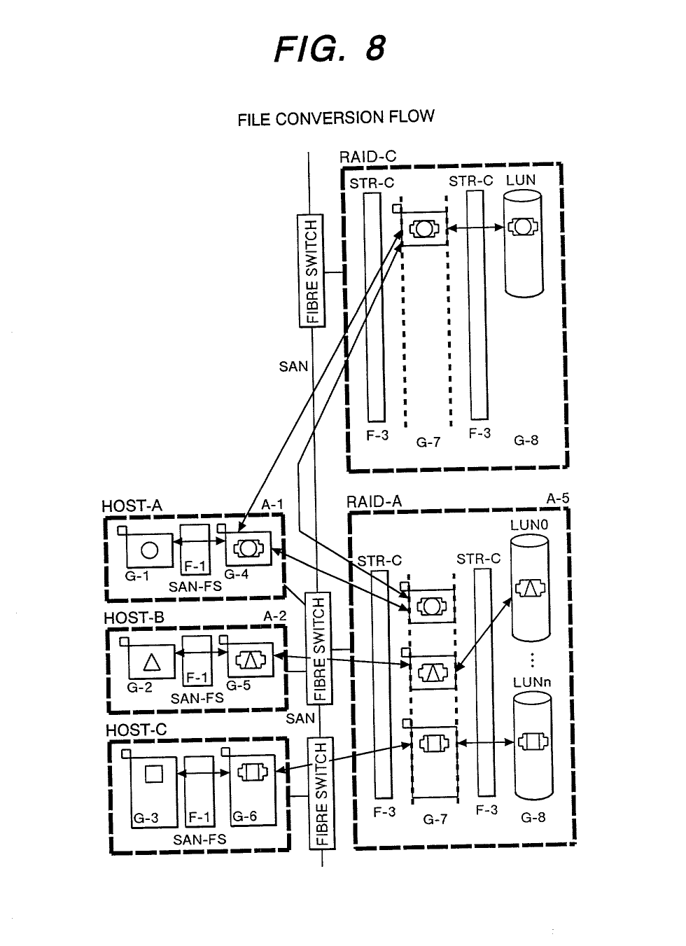

Now referring to FIG. 7 and 8, there is shown details of FIG. 1 in FIG. 7. FIG. 8 depicts the operation of the system shown in FIG. 7, more specifically the storing of host-dependent files into a RAID after converting it into the SAN format file. In the following description FIG. 7 along with FIG. 8 will be described altogether. In FIG. 8 the host A, host B, and host C may have respectively files G-1, G-2, and G-3 that are in the host-dependent format different each other and created in different file format according to their FS of FIG. 7. In FIG. 8, symbols including a circle, a triangle, and a square indicates solely that these are different files. These files will be converted by the SAN-FS shown in FIG. 7 into a format (G-4, G5, and G-6) suitable for storing and managing in a same LUN. Polygons surrounding file symbols shown in FIG. 8 indicates these files are in SAN file format.

As have been described by referring to FIG. 3, SAN-FS may have a facility of converting file formats by wrapping the SAN file format on the original files prior to storing in a LUN, instead of directly rewriting the control section of the original file specific to a host to that commonly shared by SAN. In addition, SAN-FS may also have another facility of encrypting the files to be stored with its private key at the time of conversion. Furthermore, conversely SAN-FS may have a facility of read out the files (G-4, G-5, G-6) stored in a LUN to restore to their original file formats (G-1, G-2, G-3) (reading and writing to and from a LUN may be similar to the conventional file system (FS), allowing file manipulation of files stored in the file area by modification and/or reference). At the data handling on the STR-C (Storage Controller: F-3, and F-4), any intervention by a third party (a cracker) may be prevented by checking on the network the transfer time (transmission and arrival time), proprietary encryption format, file history and the like.

STR-C (F-3 and F-4) may have a facility of allocating (staging) files read out from a LUN or files received from a host to a virtual space (G-7) in an asynchronous manner. The STR-C may also have another facility of sending asynchronously files to a host and storing (destaging) files into a LUN (G-8). The STR-C may automatically performs the conversion control, management and space allocation from the virtual space (G-7) to the real-space (G-8), as well as the real-space (G-8) to the virtual space (G-7) to smoothly perform effective exploitation of the resources. The data update of the SAN file directory in the LUN may be performed at the same time. The STR-C may also have the facility of file system, like SAN-FS. By using such STR-C, a host can be released from the occupation by only one transaction to allow file operation among the RAID devices. The STR-C will store and manage these information items into the RAID-DB on the real-time basis. The STR-C may also have a facility of requesting the update of DB (FS-DB, M-DB) to the SAN-FS and SAN-M when the RAID-DB is updated. The STR-C may have a facility of properly communicate with (transmit to) SAN-FM and SAN-M to send the update information of RAID-DB, according to the type of update, so as to communicate with (transmit to) the SAN-M and SAN-FS appropriately the crash/error information according to the type at real-time. Also, detailed information on the crash/error may be communicated (sent) to the SAN-FM and SAN-M according to the type thereof.

The SAN-M server may have a facility of requesting to obtain and rewrite (refresh) the management information of RAID-DB through the STR-C. Upon reception of the request from the STR-C, the SAN-M server will request through the STR-C to obtain and rewrite (refresh) the management information of the RAID-DB. The SAN-M server is allowed to obtain the system configuration information and system management information stored and managed sin the RAID-DB and to manage in the M-DB. The SAN-M server may have a facility of requesting the SAN-FS server to update the FM-DB, and a facility of sending system management information. The SAN-M server can receive the crash/error information transmitted in real-time from the STR-C, and may have a facility to communicate, in real-time as needed, the error information with the SAN-FM. The SAN-M server can send the error information when requested by a host or the SAN-FM, and may have a facility of generating a logical volume in the RAID (building a logical volume is part of system management information). The SAN-M server may collectively manage one group of SAN environment.

The SAN-FS server can manipulate (create, update, delete, refer, etc.) files in the management area by a host accessing to the SAN-FM server. The SAN-FS server can obtain the system management information from the SAN-M to manage in the FS-DB. The SAN-FS server may have a facility of using the system management information as a key to read and write the detailed SAN file directory information through the STR-C, and may have a facility of managing thus obtained information in the FS-DB. The SAN-FS server can receive the crash/error information transmitted in real-time from the STR-C. The SAN-FS server may have a facility to communicate, in real-time as needed, the error information transmitted in real-time from the STR-C. The SAN-FS server may collectively manage the file data in one SAN environment group by name.

There are, as drivers, Fibre channel driver, SCSI driver, ioctl (input/output control) driver, and Fibre driver and lower and upper class drivers that support them, these drivers may have a facility to obtain file data from the RAID through the SAN and may function according to the instruction by the SAN-FS.

NET-M (F-9 to F-13) may have a facility to transport the system management information and system error information over the standard transport protocols.

SAN (Storage Area Network) may be used as a network for transporting LUN information such as detailed SAN file directory (C-1) and file area (C-2). Although not shown in the figure, a database management system (DBMS) will manage the databases including RAID-DB, FM-DB, M-DB, G-DB. The file system (FS) may be allowed to have file formats, which may be different from one operating system to another.

Now returning to FIG. 8, files converted and transferred to G-7 will be stored in either of a plurality of LUN in the RAID A, or in the LUN of RAID C, which is connected by the SAN and attached to another fibre switch. The file stored in G-7 may be simply transferred among RAID devices connected to the SAN.

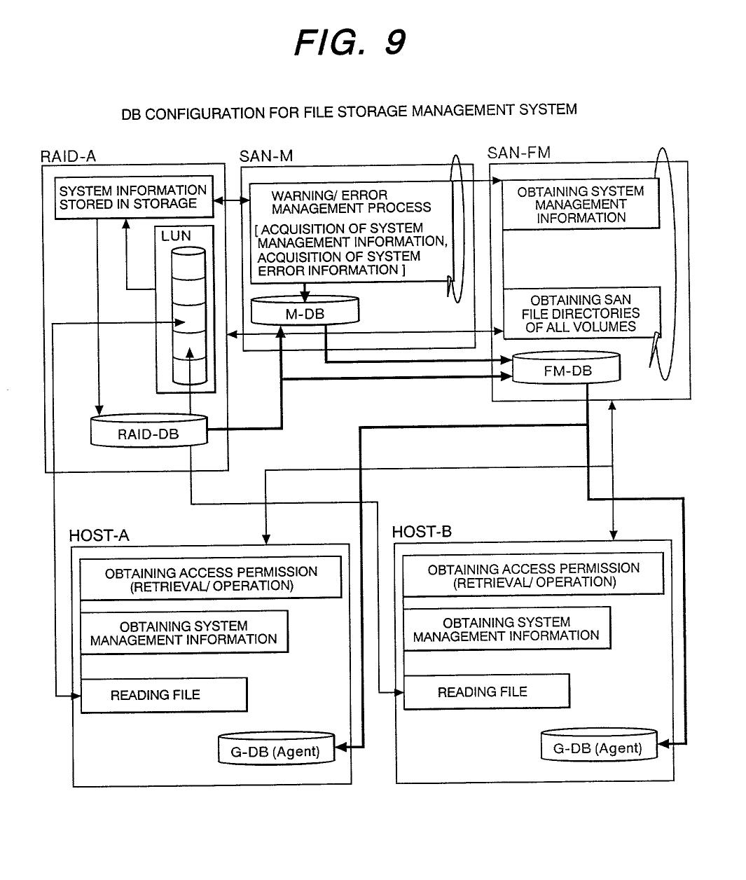

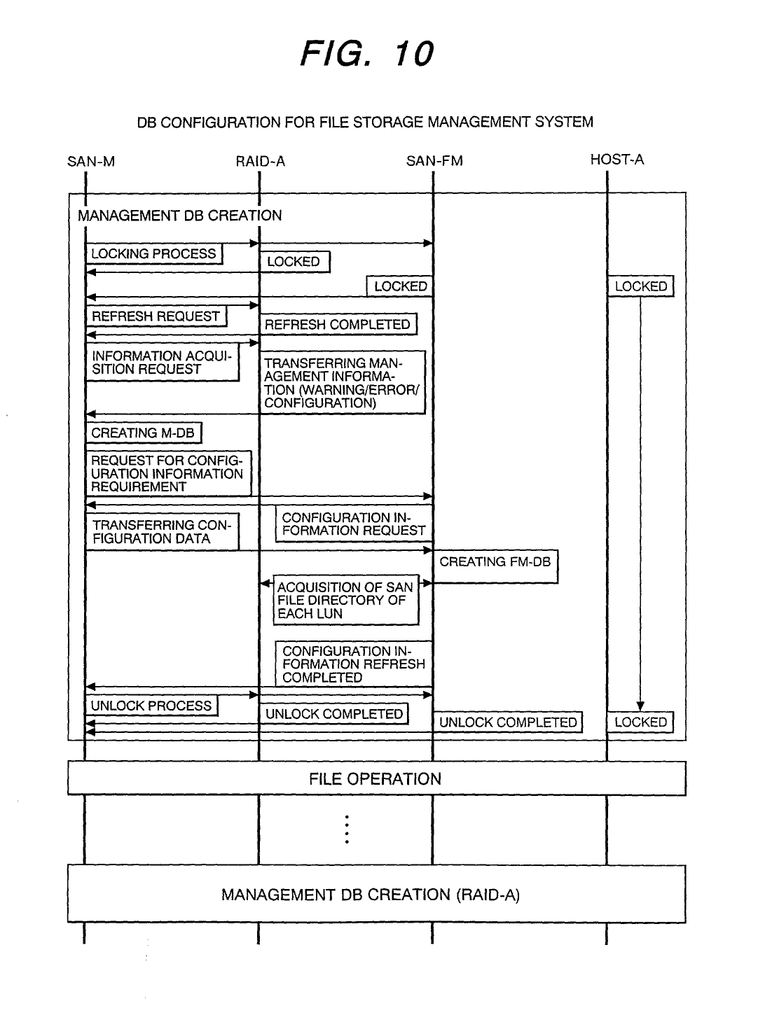

Now referring to FIG. 9 and FIG. 10, a case of building a DB will be detailed. In the following description, the upper half of FIG. 9 and FIG. 10 will be referred to mainly. The SAN-M will create each volume in the RAID A (partial system update), while the RAID A will update the system (system management information, system error information and the like) upon completion of partitioning so as to update the RAID-DB, and respond to SAN-M when the update of RAID-DB is completed by telling that the RAID-DB has been built. The SAN-M, upon reception of the response, request and obtain any necessary system management information and system error information from the RAID-DB to update the M-DB.

The SAN-M upon the completion of M-DB update, will request the SAN-FM to update the FM-DB. The SAN-FM in reply to the request will request the SAN-M to send the system management information. The SAN-M, in reply to the request, will send the system management information to the SAN-FM, while SAN-FS will use thus transmitted information to update the FS-DB and will reply the SAN-M, upon completion of building the FS-DB, that the building has been completed. Thereafter the SAN-FS will access to all volumes in the connected RAID according to the information to obtain the details of SAN file directories in order to manage them in the FS-DB. Any access to the SAN-M, the RAID devices and the SAN-FS will be blocked (prohibited) for every hosts.

On the data transfer, single-, double- triple-phase commitment will be performed as needed in order to improve the reliability. When building file management system database, each RAID device should be processed at a time, and the refreshment of database after having been configured will be on the part to be updated (once the DB is configured only the difference will be updated). The timing of building the file management system database may be arbitrarily set by the administrator (operator) of the SAN, and the update may be automated and scheduled at a regular interval.

Next, referring to FIG. 10 the flow of building databases will be detailed. Although in the following description only the RAID A will be focused, the similar operation will be done on the RAID B. Furthermore, although the host A will be cited as host, the host B may be substituted therewith.

The SAN-M has the top priority of commanding to build a database. The SAN-M will command to lock the RAID A and SAN-FM. The RAID A and SAN-FM in response, will perform locking and response to the SAN-M that the locking is completed. Thereafter the host A will not have access to file in the RAID A, unless the lock will have been released.

Then, the SAN-M will issue the refreshment request to the RAID A. The term refreshment herein refers to the update of data. When the RAID A completes the refreshment it will send back the information on the completion of refreshment to the SAN-M, which in turn will issue the request of obtaining information. The RAID A will in response thereto send back crash/error/configuration management information. The SAN-M will build the M-DB according to thus obtained information.

Requesting by the SAN-M a request for configuration information will trigger the SAN-FM to issue a request for the configuration information. In response thereto, the SAN-M will send the configuration information. The SAN-FM thereby will build the FM-DB. Thereafter, the SAN-FM will obtain from the RAID A the SAN file directories in every LUNs. In the RAID A there are LUNS from LUN0 to LUNn. The SAN-FM will specify each of these one at a time to obtain the directories. Then the SAN-FM will notify the SAN-M that the refreshment of configuration information has been completed. Then, the SAN-M will command the RAID A and the SAN-FM to release the locking. The RAID A and the SAN-FM will response to the SAN-M that the lock release has been completed. There after the host A can again have access to manipulate files. In this manner, the database concerning the configuration information on the logical volumes in the RAID A will be built in the FM-DB. In this manner, the configuration DB of logical volumes in the RAID A will be created in the FM-DB shown in FIG. 9.

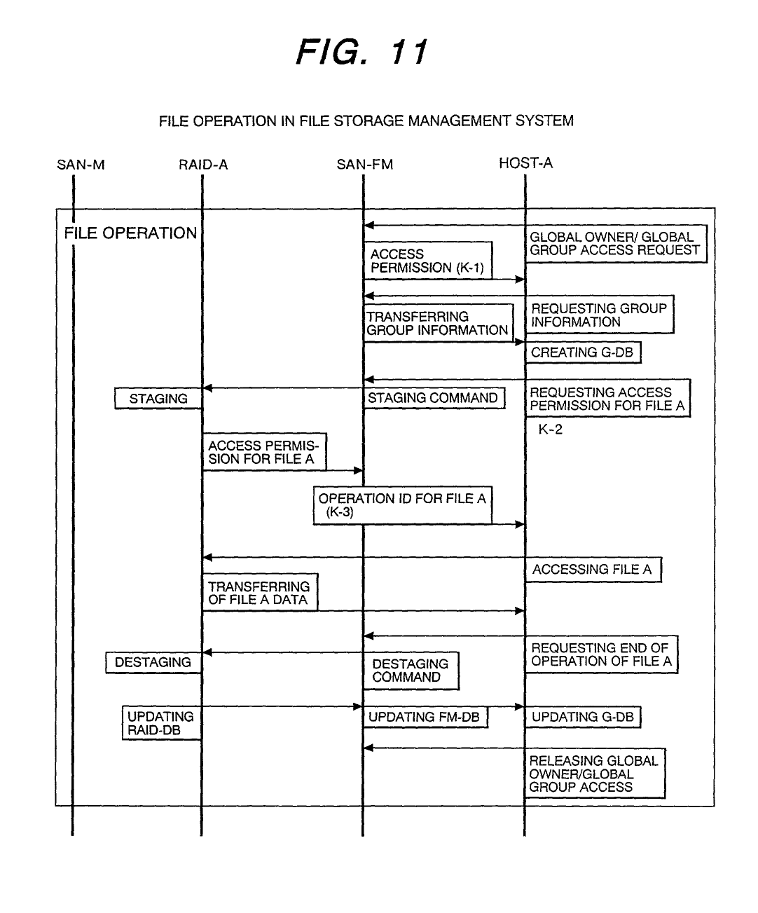

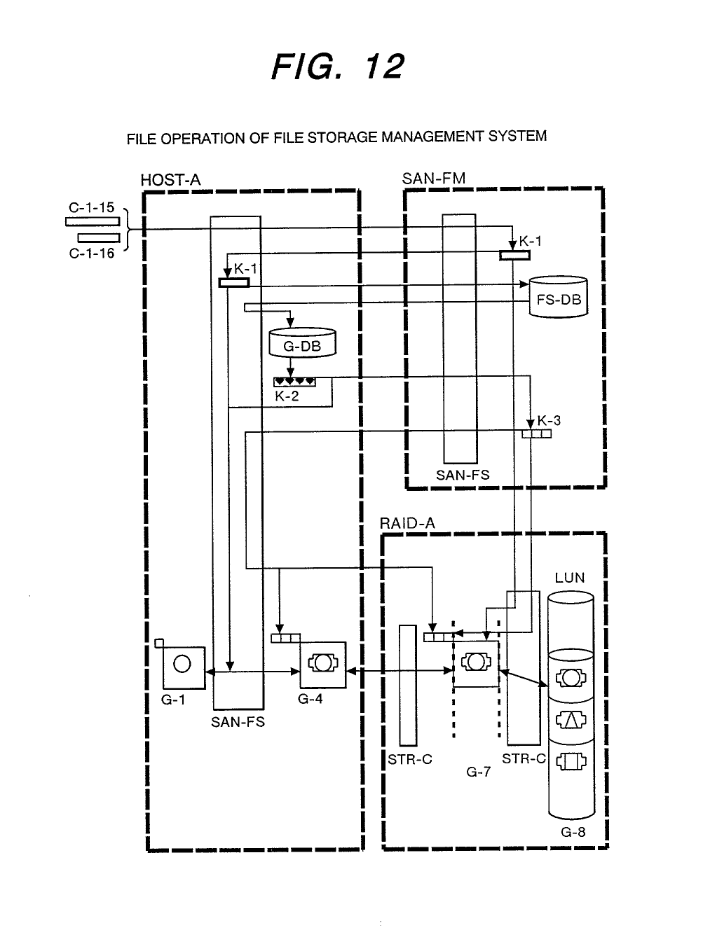

Next, the host A will perform the file manipulation 1. This process steps will be described by referring to FIG. 11 and FIG. 12. Thereafter the rebuilding of database on the RAID A will be performed as have been described above.

Now referring to FIG. 11 and FIG. 12, an exemplary file operation will be described herein below, in which an operator A uses the host A to refer or update a file A managed by the RAID A when the file management system database has been successfully built.

When the operator A on the host A enters to the SAN-FM as a global owner name (C-1-15) and global owner group name (C-1-16) arbitrary selected, the SAN-FM will check the received global owner name and global owner group to see whether the pair is suspicious or not. If cleared, a unique SAN participant ID (K-1) for that ID will be generated by the internal private key and the internal process to send to the host A. The SAN participant ID (K-1) is the ID used within the SAN-FM, and disclosed to neither host A nor operator A. The operator A will send thus obtained SAN participant ID to the SAN-FM to obtain the system management information on the system that the operator administers in order to manage within the G-DB. The operator A may see the presence of the file A and the route information of the file A from thus obtained information. The operator will ask the SAN-FM the operation request on the file A by adding the file name of the file A (K-2) to the SAN participant ID. The SAN-FM receiving the request will generate the file operation ID (K-3) of the file A for use in the operation on the access right, security, identification key of the file A, if the operation on the file A is allowed.

Then, the SAN-FM will add an operation ID of file A (K-3) to request to the RAID A the staging of file A. The RAID A upon reception of that command will move the file A from the real space (G-8) to the virtual space (G-7) to add the file A operation ID (K-3) to that file A (staging step). The file A having been staged will be encrypted with the SAN participant ID (K-1) (the file A may be encrypted at the STR-C if not encrypted here), or a preliminary space will be allocated to the file A if the file A is a new file to be encrypted. By sharing the SAN participant ID between the host and the RAID and accessing in a proprietary file format, any alteration, data manipulation and data replacement by a cracker may be checked over the host-to-RAID communication.

The RAID A will respond to the SAN-FM with the file A access permission, if the staging is cleared. The SAN-FM will send the file A operation ID (K-3) to the host A if the response from the RAID A is cleared, or the information on the problem to the host A if a problem occurs. The operator A will send the file A operation request to the RAID A with the route information and the received file A operation ID (K-3) to obtain the file A that is allocated to the virtual space. Thus obtained file A will be checked by using the SAN participant ID (K-1) and converted the file type and/or decoded to a file format operatable in the file system (FS) specific to the host A. The conversion here means the file wrapped by the file directory in the SAN format, which is indicated in FIG. 12 by a circle surrounded by a polygon, will be decoded to a file of the file type specific to the host A, shown by only a circle in FIG. 12. In this manner, an application program on the host A is allowed to operate on the file.

The data operation (referring/updating) on the file A data will be performed between the host and the RAID. When the operator A terminates the file operation on the file A, the operator will send the file A operation termination request to the SAN-FM by appending the SAN participant ID (K-1) and the file A operation ID (K-3) added thereto. The SAN-FM will check the ID and add the SAN participant ID and the file A operation ID by that command to request the destaging to the RAID A, which in turn will check the ID and then check the file A to destage it. When destaging successfully completed, the RAID A will send the information on thus updated RAID-DB to the SAN-FM. The SAN-FM will use that information to update the FS-DB and to send the information to the host A as well.

The host A, which may determine based on the information sent whether the process has successfully terminated or abnormally terminated, will update the G-DB with the update information and notify the operator A of the result of update. The DB update of the file A maybe involuntary or explicit operation, the database update and commitment will be performed in the order from the RAID A to the SAN-FS to the host A even during the file operation (commitment of SAN file directory and system management information).

Then, a problematic case, so-called the capacity error, in which the file size has been increased as the result of file manipulation on the file A so that the file will not be fit in the volume, will be described below.

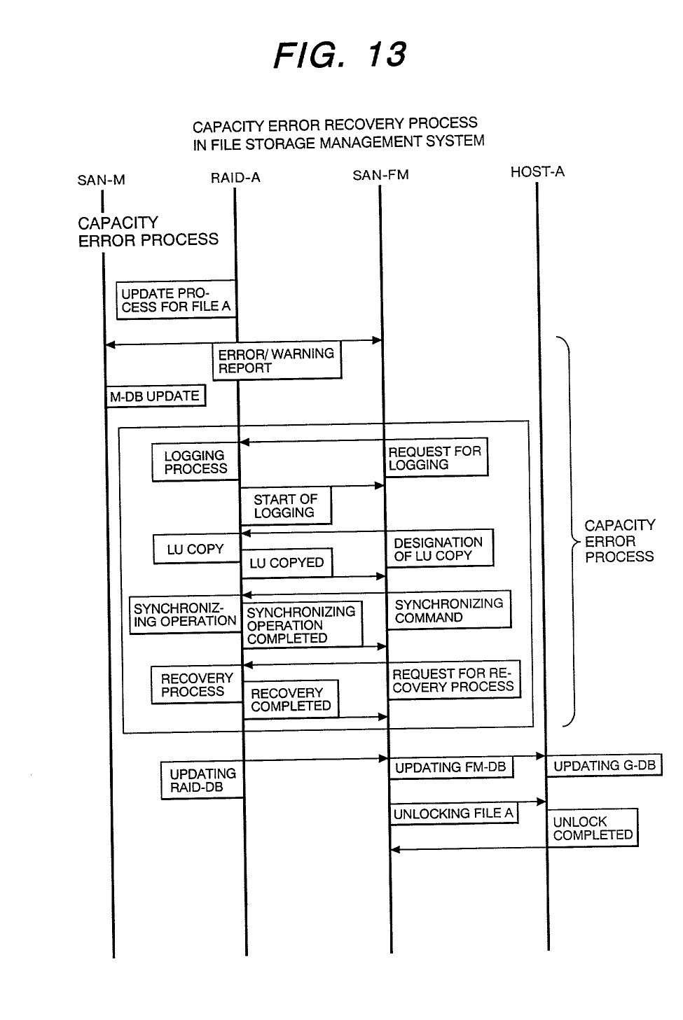

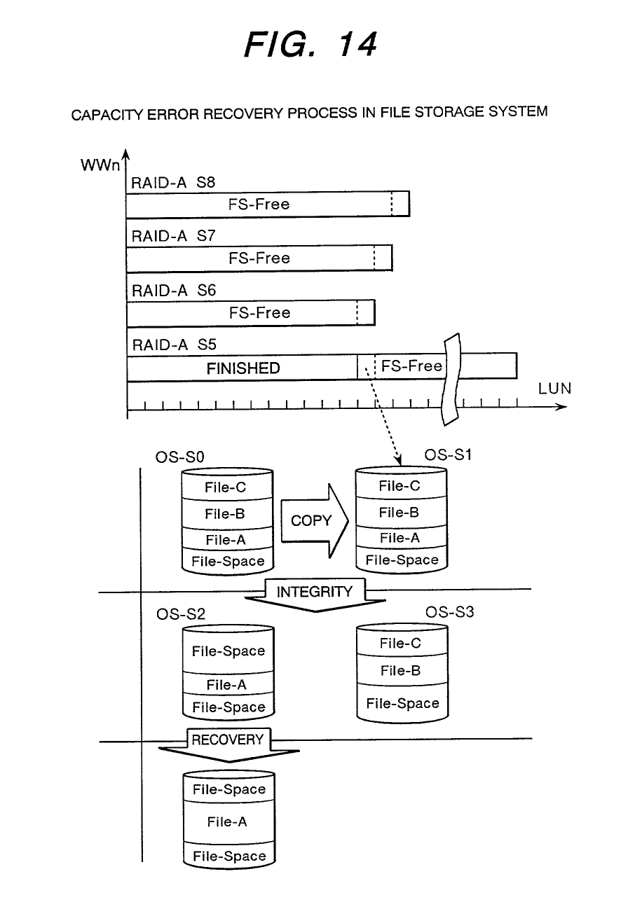

Now referring to FIG. 13 and FIG. 14, a preferred embodiment is presented in case of capacity error during the file operation on the file A. When the free available file space for the OS-S0 becomes less than the least required amount while operating the file A in the OS-S0, or when a problem occurs in the storage area during destaging, the RAID A will send a message “capacity error” to the SAN-M as well as to the SAN-FM. The SAN-FM upon reception of the message “capacity error” will request to the RAID A to log the update data of the file A (logging file for the file A) so as not to affect to the file A operation by the operator A, then the RAID A will start creating the log for the file A in response to the command (for example, the transaction will be in progress during this process). The SAN-FM upon reception of the message of starting creating the log file from the RAID A will check every LUN devices on the SAN to determine the most appropriate LUN available at that moment for mirroring, and will request to the RAID A a mirroring (OS-S0 to OS-S1). When the mirroring is completed, the RAID A will respond to the SAN-FM. The LUN available may be determined by referring the configuration as shown in FIG. 6. More specifically, the free available space may be determined by calculating the total space for each LUN and the total amount of files present, and subtracting the total amount of files from the total space. The mirroring consists of creating a copy of a volume in the LUN with the free available space.

Then, the SAN-FM will request the integrity check to the RAID A (OS-S0 to OS-S2, OS-S1 to OS-S3) (by deleting one of duplicated files). The RAID A will respond to the SAN-FS when the integrity check is completed (a volume may be automatically or explicitly reconfigured in order to prevent the fragmentation of files between LUN or RAID devices).

Thereafter, the SAN-FM will request the recovery. The RAID A in response will use the log of the file A to recover the file A to the status quo. The log file for the file A can be automatically deleted after recovery. When the recovery is completed, the RAID A will respond to the SAN-FS. The area reserved for the file A will be enlarged and secured.

In accordance with the present invention, an manager device may perform the management on the file-by-file basis of the data stored in storage devices using a rewritable recording medium, and the file-by-file based backing-up and security management independent of the device in the superior level, while at the same time a file management system may be achieved with which the user system does not need to recognize the presence of each storage device.

As many apparently widely different embodiments of this invention may be made without departing from the spirit and scope thereof, it is to be understood that the invention is not limited to the specific embodiments thereof except as defined in the appended claims.

What is claimed is:

1. A data management system for storages, suitable for a system having a host and a plurality of storages connected to a data transfer network, comprising:
a converter facility for converting a block (unity) of semantically significant data specific to an operating system (OS) on said host into a unity of semantically significant data common to said data transfer network; and
a management facility for managing a readout of said unity of data from one of said storages upon reception of the unit name of said data from said host, said facility being provided apart from said host.

2. A data management system according to claim 1, wherein:
said unity of semantically significant data specific to said operating system is comprised of actual data section and a first control section for defining the type of data specific to said operating system,
said converter facility considers the entire unity as said actual data to add to said unity of data specific to said operating system a second control section created for managing the type of data and for being common to said data transfer network.

3. A data management system according to claim 2, wherein:
said data transfer network is a storage area network.

4. A data management system for storages suitable for a system having a host and a plurality of storages connected to a data transfer network, comprising:
a converter facility for converting files in a first format having a file format specific to an operating system on said host into files in a second format having a file format common to said data transfer network; and
a management facility for managing a readout of files in said second format from one of said storages upon reception of file operation request to said storages from said host, said facility being provided apart from said host.

5. A data management system according to claim 4, wherein:
said files in said first format is comprised of actual data section and a first control section for defining the type of data specific to said operating system,
said converter facility considers said entire files in said first format as said actual data to add to said files in said first format a second control section created for managing the type of data and for being common to said data transfer network.

6. A data management system for storages suitable for a system having a plurality of storages and hosts connected to a data transfer network, comprising:
a host for obtaining files from said storages;
a server for managing files present apart from said host; and
a converter facility for converting files of a format specific to an operating system on said host into a generic format file having a format of significance common to said data transfer network;
wherein said server manages the transmission of said files on said storages to said host upon reception of access permission request from said host to said files under the name of said common format file.

7. A data management system for storages according to claim 6, further comprising:
a storage for storing said common format files,
wherein:
said server issues to said storage a staging request with a file operation ID added with respect to a file requested for said access permission, and send said file operation ID on condition that any error occurs;
said storage stages said file in accordance with said staging request and add said file operation ID to said file; and
said host obtains said file by issuing a file operation request to said storage with said file operation ID added.

8. A data management system for storages, according to claim 7, wherein:
said file operation ID is for use in the acknowledgment of access right of said host.

9. A data management system for storages, suitable for a system having a plurality of storages and hosts connected to a data transfer network, comprising:
a host having a file system converting files in a file format specific to an operating system into files in a file format common on said data transfer network, and converting files in said common file format on said data transfer network into files in said file format specific to said operating system, and said host updating data in said file format specific to said operating system;
a storage having a file storage area for storing files in a format common to said data transfer network, a virtual space for retaining files that may be transmitted and received to and from said host or another storage and that is in said format common to said data transfer network, as well as a storage controller for asynchronously allocating said file read out from said storage area to said virtual space to transmit to said host said file in said virtual space.

10. A data management system for storages according to claim 8, wherein:
said data transfer network comprises a plurality of fibre switches having hosts and/or storage devices connected thereto and a storage area network for connecting these components.

11. A data management system for storages according to claim 9, wherein:
said file in said file format specific to said operating system is comprised of actual data and a file control section for defining the file type thereof;
said file system considers said actual data plus said file control section as an actual data entirely to create another file control section common to said storage area network, said file in said file format specific to said operating system being converted to a file in said file format common to said storage area network by adding said another control section to said file in said file format specific to said operating system.
